(19) United States
(12) Patent Application Publication
(10) Pub. No.: US 2005/0077129 A1
(43) Pub. Date: Apr. 14, 2005

(54) Multi-axis shock and vibration relay isolator

(76) Inventors: Joel Sloan, Granada Hills, CA (US); Frank Landavazo, Moorpark, CA (US); Michael Denice, Westlake Village, CA (US)

Correspondence Address: Albin H. Gess, Esq.;SNELL & WILMER L.L.P., Suite 1200, 1920 Main Street, Irvine, CA, 92614-7230, US

(21) Appl. No.: 10/679,574

(22) Filed: Oct. 6, 2003

(51) Int. Cl. F16F 7/00

(52) U.S. Cl. 188/266

(57) ABSTRACT

The multi-axis random vibration isolator is designed and configured to reduce the shock and vibration to electronic components. The shock and vibration isolator may include a body having a top end defining a cavity and a bottom end, a first passageway extending through the body below the cavity, and a second passageway extending through the body below the cavity, the second passageway intersecting the first passageway.

### BACKGROUND OF THE INVENTION

1. Field of the Invention

The present invention relates generally to a component isolator, and more particularly to a multi-axis shock and vibration relay isolator.

2. Description of the Related Art

Electronic components such as electro-mechanical relays can be used on air, space and launch vehicles (e.g., airplanes, satellites, space shuttles and rockets) to control the operations of the vehicles. These vehicles generally exhibit high acceleration and deceleration levels during takeoffs, landings and flights resulting in high levels of shock and vibration to its electronic components. The shock and vibration can cause the electronic components to exhibit unwanted electrical signal behavior. For example, a relay is an electronic component that when exposed to high acceleration levels can chatter or change state, resulting in unacceptable system performance. Chattering can occur when the relay is subjected to a shock or vibration that causes an armature of the relay to move from its current position. In addition, the high acceleration levels may cause internal acceleration board level amplifications to occur that may alter the behavior of the electronic components and exacerbate system performance.

FIG. 1 is perspective view of a prior art electromechanical relay 100 having a cylindrical housing 102, which has a top surface 104 and a bottom surface 106. Encapsulated within the cylindrical housing 102 are the components of the relay 100, which include a number of contacts 108 that protrude through the bottom surface 106 of the housing 102. The contacts 108 represent input, output and coil terminals that are used to directly connect the relay 100 to a printed circuit or wire board (PWB) 110. Generally, the contacts 108 are directly soldered to the PWB 110. By way of example, the relay 100 may be a Series 420/422 double pole double throw (DPDT) magnetic latching TO-5 relay, manufactured by Teledyne Relays of Hawthorne, Calif. Other types of relays may be used and will be evident to those skilled in the art.

Each electronic component typically has an acceleration threshold rating for shock and vibration. For example, the relay 100 has been manufactured and tested to withstand 2000 Gs of shock induced acceleration for 0.5 milliseconds. In many situations, the relay 100 is subjected to shock and vibration much greater than 2000 Gs, for example, 4000 Gs. Beyond 2000 Gs, the relay 100 exhibits undesirable characteristics such as chattering and state changes. Therefore, the relay 100 is unable to provide reliable functionality when shock and vibration, greater than 2000 Gs, occurs.

Several isolation systems have been developed such as spider lead mounting and dead bugging, however, these systems have been unsuccessful at decoupling the electronic component from the high accelerations developed by the application environment. In addition, these systems transmit noise and disabling accelerations directly to the electronic component. Thus, it should be appreciated that there is a need for an apparatus or device that allows conventional relays to withstand shock and vibration that is greater than 2000 Gs without exhibiting undesirable electrical signal behavior. The present invention fulfills this need as well as others.

### SUMMARY OF THE INVENTION

The present invention relates to a multi-axis shock and vibration isolator. In particular, and by way of example only, one embodiment of the present invention is a multi-axis shock and vibration isolator, which may include a body having a top end defining a cavity and a bottom end, a first passageway extending through the body below the cavity, and a second passageway extending through the body below the cavity, the second passageway intersecting the first passageway.

Another embodiment of the present invention is an isolator configured to reduce the shock and vibration of an electronic device. The isolator may include a body having a top end defined by a cavity configured to receive the electronic device. The body may have first, second, third and fourth openings positioned an equiangular distance apart from one another and positioned below the cavity. The first opening may be positioned across from the third opening and the second opening may be positioned across from the fourth opening. The body may also include a first passageway connecting the first opening to the third opening and a second passageway connecting the second opening to the fourth opening. The second passageway may intersect the first passageway.

Another embodiment of the present invention is a multi-axis shock and vibration relay isolator. The isolator may include a body having a top end, a bottom end and an outer surface in contact with the top end and the bottom end. The body may be formed of a resilient material. The isolator may also include first, second and third openings spaced an equiangular distance (for example, 90 degrees or 120 degrees) apart from each other on the outer surface and a passage connecting the first, second and third openings. The passage may be sized and shaped to provide attenuation of a desired frequency.

Advantages of the present invention may include an isolator for attenuating the shock and vibration imposed along any axis of the electronic components and providing a dynamic environment that does not affect the performance of the electronic components. The isolator may also attenuate the noise and acceleration from traveling to the electronic components. Other advantages include compact size, light weight design and reduced manufacturing cost.

These and other features and advantages of the embodiments of the invention will become apparent from the following detailed description, taken in conjunction with the accompanying drawings, which illustrate, by way of example the principles of the invention.

### BRIEF DESCRIPTION OF THE DRAWINGS

FIG. 1 is perspective view of a prior art electro-mechanical relay configured to be directly connected to a printed wire board;

FIG. 2 is a perspective view of an isolator that is designed and configured to attenuate the shock and vibration to electronic components in accordance with an embodiment of the present invention;

FIG. 3 is a cross-sectional top view of the body cut along a plane that is normal to the main axis and that passes through the diameter of the plurality of openings in accordance with an embodiment of the present invention;

FIG. 4 is a cross-sectional top view of the body cut along a plane that is normal to the main axis and that passes through the diameter of the plurality of openings in accordance with an embodiment of the present invention;

FIG. 5 is a cross-sectional side view of the body cut along a plane that is coincident with the main axis in accordance with an embodiment of the present invention;

FIG. 6 is a perspective view of a portion of the relay positioned within the cavity of the body in accordance with an embodiment of the present invention;

FIG. 7 is a cross-sectional side view of the body as shown in FIG. 5 along with a portion of the relay positioned within the cavity in accordance with an embodiment of the present invention;

FIG. 8 is a perspective view of the relay positioned on the isolator while being exposed to lateral or side-to-side movements in accordance with an embodiment of the present invention;

FIG. 9 is a perspective view of the relay positioned on the isolator while being exposed to longitudinal movements in accordance with an embodiment of the present invention; and

FIG. 10 is a graph showing the dynamic response of the isolator at a particular location on the printed wire board during random vibration excitation in accordance with an embodiment of the present invention.

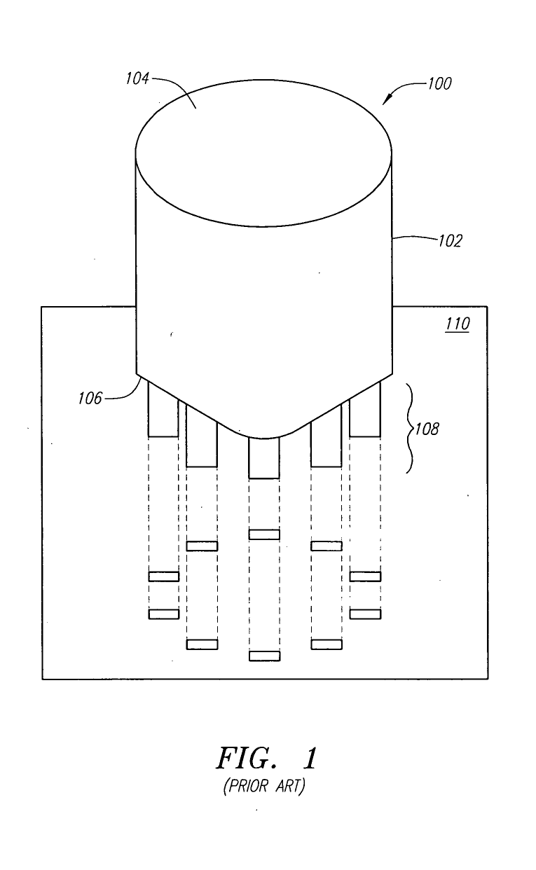

### DETAILED DESCRIPTION OF THE PRESENTLY PREFERRED EMBODIMENTS

Devices that implement the embodiments of the various features of the present invention will now be described with reference to the drawings. The drawings and the associated descriptions are provided to illustrate embodiments of the present invention and not to limit the scope of the present invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

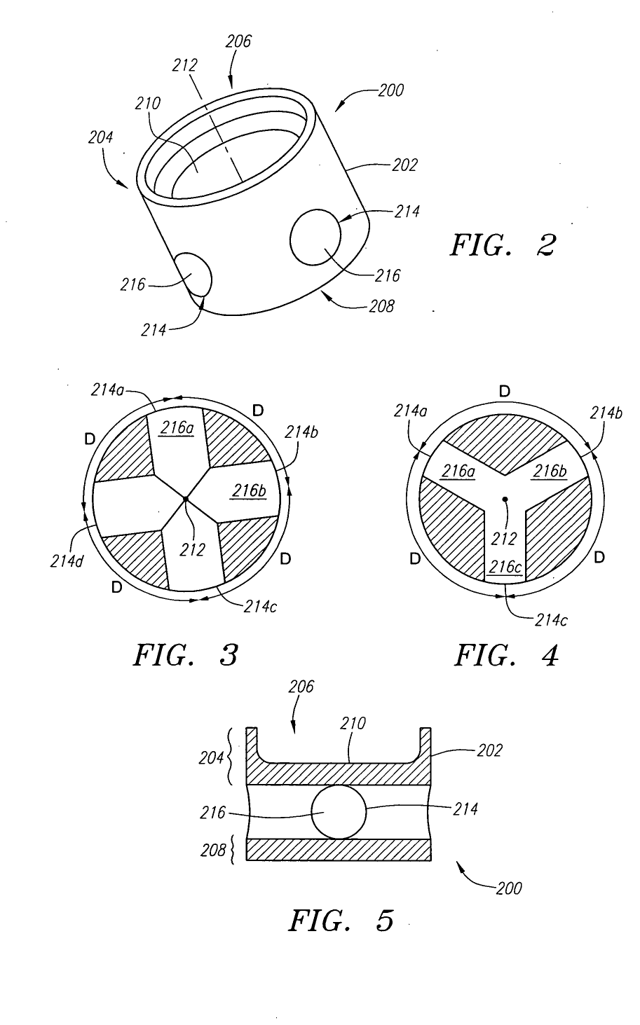

Referring now more particularly to the drawings, FIG. 2 is a perspective view of an isolator 200 that is designed and configured to attenuate the shock and vibration to electronic components (e.g., relay 100). The isolator 200 provides suspension to the electronic component so that shock and vibration effects along all axes are attenuated to levels below the acceleration threshold rating of the particular electronic component. The isolator 200 allows the electronic component to exhibit uninhibited operation at high acceleration levels and any altitude or orientation. The isolator 200 may include a body 202 having a top end 204 defining a cavity 206 and a bottom end 208. The body 202 may be formed in a shape that has geometric symmetry so that shocks and vibrations in any direction (e.g., lateral or vertical) or along any axis produces a similar frequency response. Hence, the isolator 200 may be designed to attenuate the shock or vibration at a particular frequency or range of frequencies. In addition, the isolator 200 prevents the relay 100 from chattering during rapid acceleration of the vehicle. In one embodiment, the body 202 is formed in a cylindrical shape, however, in other embodiments, the shape of the body 202 can be square, hexagon oval or elliptical. The body 202 may be made of or formed of a rubber-like elastomeric material. By way of example, the body 202 may be made of a 2119 Abtec polyurethane material, part number 7577922-001, manufactured by Abtec, Inc. of Bristol, Pa. Other types of materials may also be used and will be evident to those skilled in the art. The particular material selected should provide a modulus of elasticity that is relatively stable over time and temperature.

The top end 204 of the body 202 defines a cavity 206 that is configured to receive an electronic component. In one embodiment, and by way of example, the cavity 206 has a bottom surface 210 for supporting the electronic component (see also FIG. 5). The bottom surface 210 can be substantially flat, curved or otherwise configured depending on the shape of the portion of the electronic component that is disposed within the cavity 206. For example, in the illustrated embodiment, the relay 100 has a relatively flat top surface 104 and accordingly, the bottom surface 210 is relatively flat so that the two surfaces can substantially contact each other. The top surface 104 of the relay 100 may be glued or bonded to the bottom surface 210 of the cavity 206. To further illustrate the features or elements of the isolator 200, a main axis 212 is shown to pass through the center of the bottom surface 210 of the cavity 206 so that the bottom surface 210 of the cavity 206 is normal or perpendicular to the main axis 212.

The body 202 may further include a plurality of openings 214 where each opening 214 is located on an outer surface or shell of the body 202 below the cavity 206 and is spaced an angle D apart from an adjacent opening 214. FIG. 3 is a cross-sectional top view of the body 202 cut along a plane that is normal to the main axis 212 and that passes through the diameter of the plurality of openings 214. In the illustrated embodiment, the body 202 includes four openings 214 such that the first opening 214a is spaced an angle D from the second opening 214b, which is spaced an angle D from the third opening 214c, which is spaced an angle D from the fourth opening 214d. The diameter of each opening 214 may be 2.5 millimeters (mm) and the angle D may be 90 degrees. Hence, each opening (e.g., 214a) is spaced about 90 degrees from an adjacent opening (e.g., 214b). Each opening 214 may have a circular (shown), oval, hexagonal, elliptical, square or triangular shape. The isolator 200 may have any number of openings 214 with a selected diameter to achieve the desired stiffness.

The body 202 may also include a plurality of passageways 216 connecting the plurality of openings 214 and extending through the body 202 below the cavity 206. For example, a first passageway 216a may provide a path between the first opening 214a and the third opening 214c and a second passageway 216b may provide a path between the second opening 214b and the fourth opening 214d. Preferably, the passageways 216 have the same shape as the openings 214 and intersect at the main axis 212. In one embodiment, the openings 214 and the passageways 216 may be configured as shown in FIG. 4 where the angle D may be 120 degrees. That is, the first and second passageways 216a, 216b begin at the first and second openings 214a, 214b respectively, converge at the main axis 212 and form the third passageway 216c, which continues toward the third opening 214c. Hence, each opening (e.g., 214a) is spaced about 120 degrees from an adjacent opening (e.g., 214b). In other embodiments, each opening may be spaced about 15, 30 or 45 degrees or any other degrees apart from an adjacent opening.

The openings 214 and the passageways 216 may have any shape, size and configuration that produces a symmetrical design and maintains a uniform stiffness along any lateral axis. The geometric properties (e.g., the configuration and size of the openings 214 and passageways 216) of the isolator 200 along with the particular material of the body 202 assist in determining the stiffness of the isolator 200. Therefore, the structural behavior of the isolator 200 may be tuned by designing the openings 214 and the passageways 216 and selecting the material to produce a resulting composite stiffness that provides attenuation at a specific frequency in the excitation spectrum that limits the frequency response at resonance to below the acceleration threshold rating of the particular electronic component along any axis.

FIG. 5 is a cross-sectional side view of the body 202 cut along a plane that is coincident with the main axis 212. The cavity 206 is configured so that the relay 100 can snugly fit therein. As shown, the opening 214 and the passageway 216 are both formed in the shape of a circle and are located below the cavity 206 of the isolator 200.

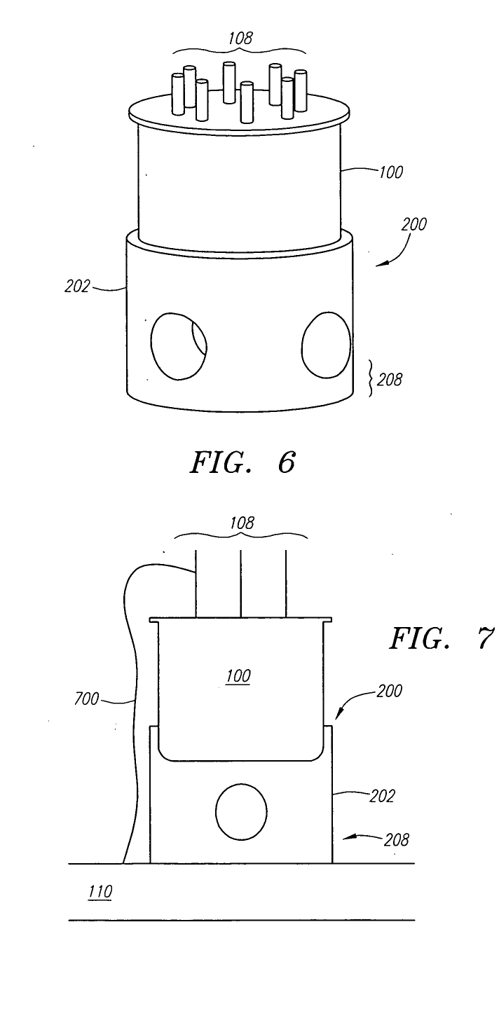

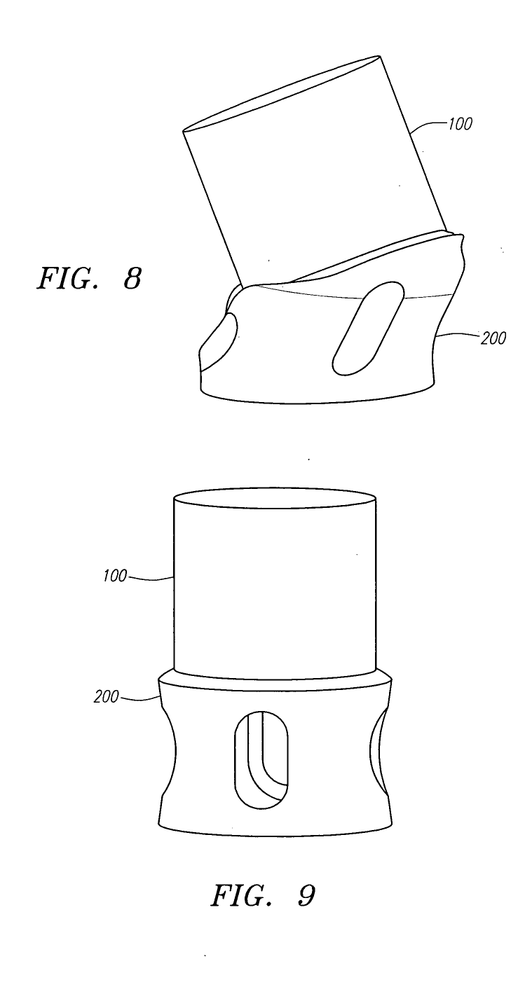

FIG. 6 is a perspective view of a portion of the relay 100 positioned within the cavity 206 of the body 202. The relay 100 is positioned such that its contacts 108 are facing away from the isolator 200. This position advantageously allows the isolator 200 to absorb most of the lateral and longitudinal movement of the relay 100 when subjected to large amounts of shock and vibration. Hence, the relay 100 is positioned so that the contacts 108 are not directly and rigidly attached, soldered or mounted to the PWB 110. The direct and rigid soldering of the contacts 108 to the PWB 110 causes the relay 100 to experience abrupt and rapid movement resulting from shock and vibration to the PWB 110. In one embodiment, the bottom end 208 of the isolator 200 is glued or bonded to the PWB 110 to attenuate the shock and vibration experienced by the PWB 110 from traveling to the relay 100. The isolator 200 may be attached to the PWB 110 anywhere that the relay 100 may be attached. The compact size allows the isolator 200 to be attached at multiple locations on the PWB 110.

FIG. 7 is a cross-sectional side view of the body 202 as shown in FIG. 5 along with a portion of the relay 100 positioned within the cavity 206. The body 202 has a cylindrical shape with a diameter of about 9.5 mm and a height of about 7.0 mm and the cavity 206 has a diameter of about 8.4 mm and a depth of about 1.8 mm. The relay 100 is positioned such that its contacts 108 are facing away from the isolator 200. The contacts 108 are electrically connected to the PWB 110 by electrical conduits 700 (e.g., flexible wires) and allow for the movement of the relay 100 in lateral and longitudinal directions. The bottom end 208 of the isolator 200 may be glued or bonded to the PWB 110. The relay 100 is mounted to the isolator 200, which is mounted to the PWB 110 so that shock and vibration to the PWB 110 are not directly coupled or translated to the relay 100.

FIG. 8 is a perspective view of the relay 100 positioned on the isolator 200 while being exposed to lateral or side-to-side movements. As shown, the isolator 200 is severely deformed and absorbs most of the shock and vibration. Therefore, the relay 100 is exposed to a lesser amount of abrupt movements, thus minimizing the amount of shock and vibration to the relay 100. The isolator 200 exhibits essentially uni-modal behavior along each of the three axes (2 lateral axes and 1 vertical axis).

FIG. 9 is a perspective view of the relay 100 positioned on the isolator 200 while being exposed to longitudinal movements. As shown, the isolator 200 is severely deformed and absorbs most of the shock and vibration. Therefore, the relay 100 is exposed to a lesser amount of abrupt movements, thus minimizing the amount of shock and vibration to the relay 100.

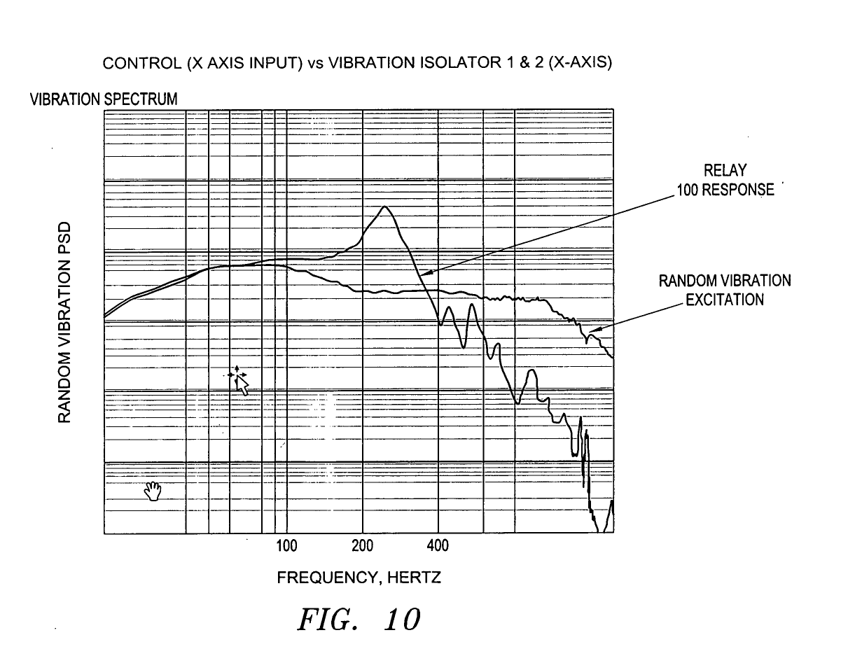

FIG. 10 is a graph showing the dynamic response of the isolator 200 at a particular location on the PWB 10 during random vibration excitation. The x-axis represents the frequency spectrum of the isolator 200 excitation and the y-axis represents the vibration response across the frequency spectrum. The isolator 200 provides attenuation of acceleration levels above about 1.4 times the resonant frequency of the isolator 200. For example, the 240 Hertz (Hz) isolator 200 provides acceleration attenuation above 340 Hz. Therefore, PWB resonant acceleration peaks that occur at about 450 to 900 Hz (as shown in FIG. 10) are attenuated by the isolator 200 to acceptable component acceleration levels for relay 100.

Although an exemplary embodiment of the invention has been shown and described, many other changes, combinations, omissions, modifications and substitutions, in addition to those set forth in the above paragraphs, may be made by one having skill in the art without necessarily departing from the spirit and scope of this invention. Accordingly, the present invention is not intended to be limited by the preferred embodiments, but is to be defined by reference to the appended claims.

1. A multi-axis shock and vibration isolator, comprising:
a body having a top end defining a cavity and a bottom end;
a first passageway extending through the body below the cavity; and
a second passageway extending through the body below the cavity, the second passageway intersecting the first passageway.

2. The isolator as defined in claim 1, wherein the body has a circular cross section when cut along a plane perpendicularly intersecting a main axis thereof.

3. The isolator as defined in claim 1, wherein the first and second passageways have a substantially cylindrical shape.

4. The isolator as defined in claim 1, wherein the first passageway is positioned along a first axis and the second passageway is positioned along a second axis, the second axis being substantially perpendicular to the first axis.

5. The isolator as defined in claim 1, wherein the first axis lies along the same plane as the second axis.

6. The isolator as defined in claim 1, wherein the cylindrical body is formed of a resilient member.

7. The isolator as defined in claim 1, wherein the cylindrical body is formed of a hard elastomeric material.

8. The isolator as defined in claim 1, further comprising a third passageway extending through the cylindrical body and along a third axis.

9. The isolator as defined in claim 1, wherein the cavity is configured to receive a relay.

10. An isolator configured to reduce the random vibration of an electronic device, the isolator comprising:
a cylindrical body having
a top end defined by a cavity configured to receive the electronic device,
first, second, third and fourth openings positioned an equiangular distance apart from one another and positioned below the cavity, the first opening being positioned across from the third opening and the second opening being positioned across from the fourth opening,
a first passageway connecting the first opening to the third opening, and
a second passageway connecting the second opening to the fourth opening, the second passageway intersecting the first passageway.

11. The isolator as defined in claim 10, wherein the first, second, third and fourth openings are located on an outer surface of the cylindrical body.

12. The isolator as defined in claim 10, wherein the first, second, third and fourth openings are circular in shape.

13. The isolator as defined in claim 10, wherein the first and second passageways are cylindrical in shape.

14. The isolator as defined in claim 10, wherein the first and second passageways are sized and shaped to attenuate a specific frequency.

15. A multi-axis shock and vibration relay isolator, comprising:
a body having a top end, a bottom end and an outer surface in contact with the top end and the bottom end, the body being formed of a resilient material;
first, second and third openings spaced an equidistance apart from each other on the outer surface; and
a passage connecting the first, second and third openings.

16. The isolator as defined in claim 15, wherein the top end is defined by a cavity for receiving an electronic component.

17. The isolator as defined in claim 15, wherein the passage is sized and shaped to provide attenuation of a desired frequency.

18. The isolator as defined in claim 15, wherein the first, second and third openings are circular in shape.

19. The isolator as defined in claim 15, wherein the passage in cylindrical in shape.

20. The isolator as defined in claim 15, wherein the first, second and third openings and the passage provide a substantially uniform stiffness along any lateral axis.
